(19) United States
(12) Patent Application Publication
(10) Pub. No.: US 2026/0050847 A1
(43) Pub. Date: Feb. 19, 2026

(54) SYSTEM, METHOD, APPARATUS, AND COMPUTER PROGRAM PRODUCT FOR JURISDICTIONALLY COMPLIANT STAFFING MANAGEMENT WITHIN CORRECTIONS FACILITIES

(71) Applicant: William David Colon, Warwick, NY (US)

(72) Inventor: William David Colon, Warwick, NY (US)

(21) Appl. No.: 19/288,901

(22) Filed: Aug. 1, 2025

Related U.S. Application Data
(63) Continuation-in-part of application No. 17/655,079, filed on Mar. 16, 2022, now abandoned.

(51) Int. Cl. G06Q 10/0631; G06Q 10/0633

(52) U.S. Cl. CPC G06Q 10/06311; G06Q 10/06334

(57) ABSTRACT

A system, method, apparatus, and computer program product that provides a strategically integrated interdisciplinary staffing and budgetary management system for staffing of corrections facilities. The Constitutional Public Safety Staff Management System (CPSSMS) incorporates effective methodologies for regulating the staffing management of public and private sector organizations as it pertains to the administrative governance of domestic public safety organizations within the American criminal justice system. The CPSSMS include a Schedule Mapping Tool; a Tour, Group, Squad Balance Calibration Tool; an Enhanced Overtime Code Mapping Tool; an Overtime Tracking System; a Governed System Compliance Engine; and a Sequential Staff Sort System. The CPSSMS provides for operational staffing of the corrections facility and can be utilized for documenting requirement shortfalls for obtaining legislative and other budgetary requirements to maintain humane conditions and constitutional standards of confinement that promote the general welfare of individuals held within an institutional jail or prison setting.

### CROSS-REFERENCE TO RELATED APPLICATION

This application is a continuation-in-part of U.S. patent application Ser. No. 17/655,079, filed Mar. 16, 2022, the contents of which are herein incorporated by reference.

### BACKGROUND OF THE INVENTION

The present invention relates to corrections facilities, and more particularly to determining jurisdictionally compliant staffing management within corrections facilities.

Correctional facilities in the United States confront persistent challenges: understaffing, non-compliance with legal standards, and budgetary inefficiencies driven by outdated management practices. These issues undermine the constitutional obligations of care, custody, and control, compromising safety and rehabilitation outcomes.

An optimal criminal justice system requires the establishment of measures that can be applied to every State that are bound by the Constitution for the United States of America. Throughout the United States today many government law enforcement agencies and privately operated organizations are going through very challenging times in the management of jails and prisons within the criminal justice system. Corrections facilities are subject to state and federal Constitutional, statutory, rules and codes, specifying standards for the operation of corrections facilities. For those facilities that have had a history of non-compliance, additional standards may also be included those imposed in the form of consent decrees or adverse judgments.

While the physical facilities are subject to certain standards, a significant component of correctional facility deficiencies can be attributed to inadequate staffing levels in operating the correctional facility. Current staffing management tools are not comprehensive enough to ensure compliance with jurisdictional guidelines governing the operation of the corrections facility. Likewise, compliance with collective bargaining agreements and other contractual agreements may often become subject to constraints by the inability to staff the corrections facility in a comprehensive manner.

As can be seen, there is a need for improved systems, methods, apparatus, and computer program products to provide jurisdictionally compliant staffing management within corrections facilities.

### SUMMARY OF THE INVENTION

In one aspect of the present invention, a system for corrections facility staffing management within a corrections facility is disclosed. The system includes a Schedule Mapping Tool that is configured to create an architecturally structured authorized staff work schedule based on a data extraction of an authorized staffing level specified in an operative table of organization for the corrections facility. A Governed System Compliance Engine is configured to validate the architecturally structured authorized staff work schedule based on a plurality of jurisdictional standards specified for a minimum operational staffing of the corrections facility, to create a validated architecturally structured authorized staff work schedule defining one or more authorized position requirements for maintaining for a minimum staffing for a compliant operation of the corrections facility.

In some embodiments, a Tour, Group, Squad Balance Calibration Tool is configured to provide a mapping of an authorized, an actual, and an unavailable staff against the one or more authorized position requirements specified in the validated architecturally structured authorized work schedule. The authorized position requirements are designated by a positional rank for each of a shift, a tour group, and a rotation.

In some embodiments, an Overtime Tracking System is configured to determine an operational gap in hours between an available staff and the one or more authorized position requirements. The operational gap is determined for each shift, tour, group, and rotation, during a specified temporal period. The Overtime Tracking System is configured to longitudinally map the operational gap in one or more predictive forecasts.

In some embodiments, an Enhanced Overtime Code Mapping Tool is configured to determine a full-time equivalent headcount required to fulfill the operational gap. The full-time equivalent headcount is determined by a positional rank, and a salary hour of coverage provided by said full-time equivalent headcount. The Enhanced Overtime Code Mapping Tool may also be configured to determine a full coverage factor requirement as in-budget according to one or more overtime code categories and one or more sub-groups within said one or more overtime code categories. The Enhanced Overtime Code Mapping Tool may also be configured to determine a full coverage factor requirement as out-of-budget according to one or more emergency events outside of a budgeted headcount.

In some embodiments, a Sequential Staff Sort System is configured to assign a roster of assigned personnel to each of the one or more authorized position requirements of the validated architecturally structured authorized staff work schedule. The roster of assigned personnel maintains operational continuity in one or more of a staff, a platoon, or a group. The roster of assigned personnel may also account for scheduling of a contractual fringe benefit.

These and other features, aspects and advantages of the present invention will become better understood with reference to the following drawings, description and claims.

### BRIEF DESCRIPTION OF THE DRAWINGS

FIG. 1 is a representative system flow and architecture for the Constitutional Public Safety Staff Management System.

FIG. 2 is a representative Table of Organization.

FIG. 3 is a representative implementation of an Operative Organizational Daily Overtime Tracking Report.

FIG. 4 is a representative implementation of Tour, Group, Squad Balance Calibration Tool.

FIG. 5 is a continuation of the Tour, Group, Squad Balance Calibration Tool.

FIG. 6 is a representative implementation of a Sequential Staff Slot System.

FIG. 7 is a representative compliance visualization tool of a Governed System Compliance Engine.

FIG. 8 is a flowchart illustrating an implementation of a Schedule Mapping Tool (SMT).

FIG. 9 is a flowchart illustrating an implementation of a Tour, Group, Squad Balance Calibration Tool (TGSBCT).

FIG. 10 is a flowchart illustrating an implementation of an Overtime Tracking System (OTS).

FIG. 11 is a flowchart illustrating an implementation of an Enhanced Overtime Code Mapping Tool (EICMT).

FIG. 12 is a flowchart illustrating an implementation of a Sequential Staff Sort System (SSSS).

FIG. 13 is a flowchart illustrating a Governed System Compliance Engine (GSCE).

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus, and computer program product that provides a strategically integrated interdisciplinary staffing and budgetary management system for staffing corrections facilities. The Constitutional Public Safety Staff Management System (CPSSMS) according to the present invention incorporates effective methodologies for regulating the staffing management of public and private sector organizations as it pertains to the administrative governance of domestic public safety organizations within the American criminal justice system.

The CPSSMS, redefines workforce management in correctional facilities by integrating multivariable calculus, backpropagation, and empirical algorithmic machine learning (ML) across its components, all orchestrated by the Governed System Compliance Engine (GSCE). The CPSSMS leverages multivariable calculus, backpropagation, and empirical algorithmic machine learning (ML) to transform workforce operationalization, treating staffing variables as interdependent functions within a higher dimensional, adaptive system. This application describes how the CPSSMS, with ML programmed into each function and managed by the GSCE, ensures a jurisdictionally compliant, scalable solution for correctional institutions.

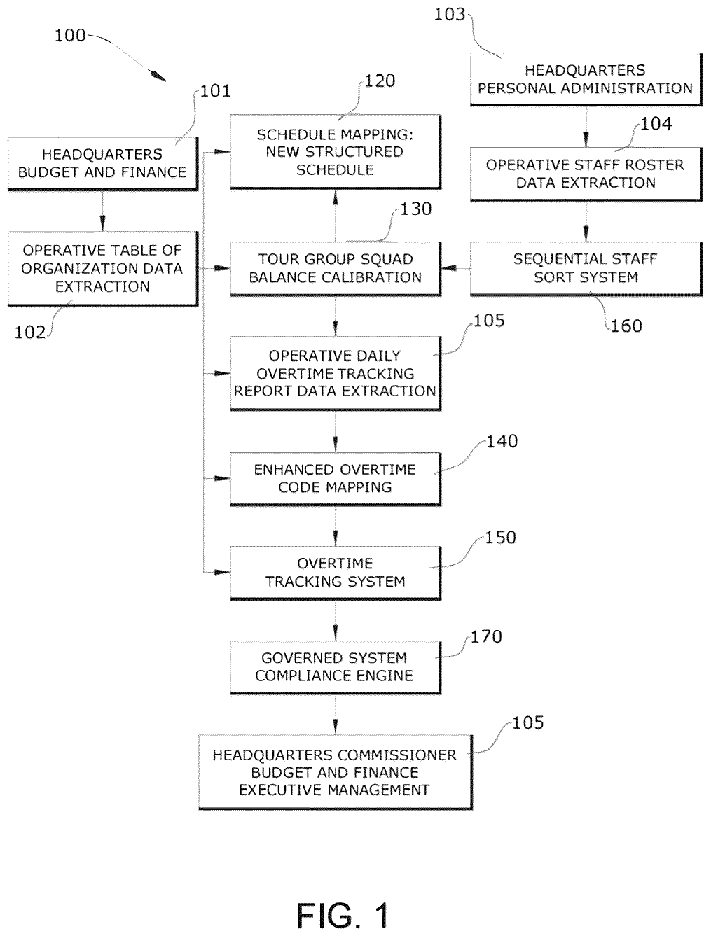

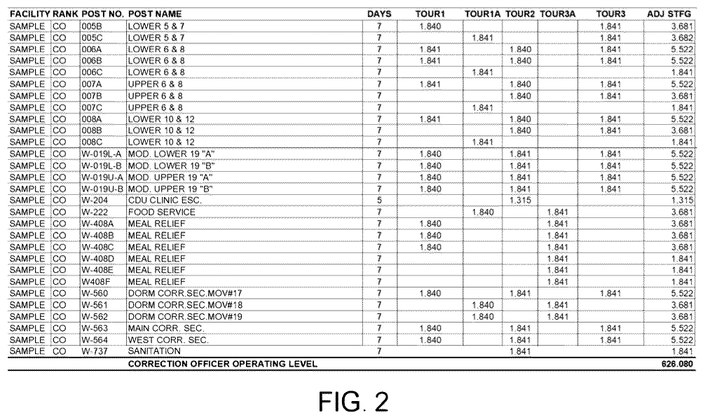

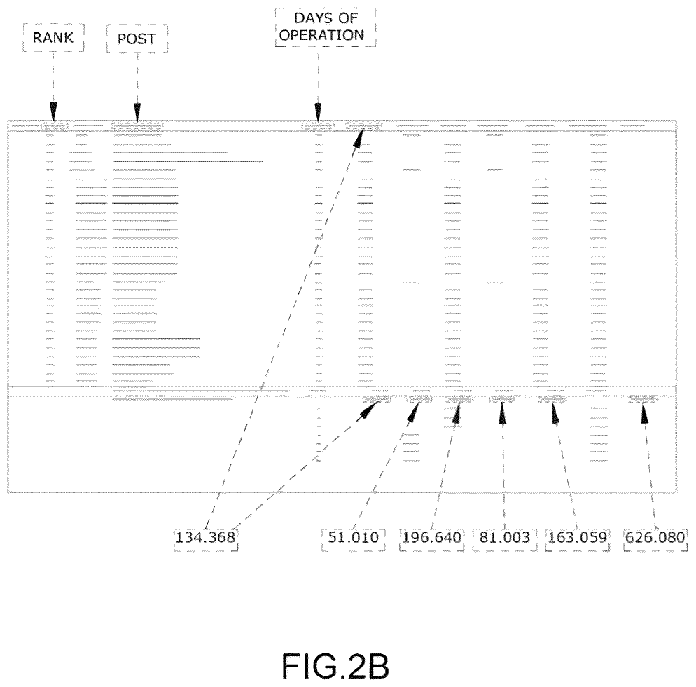

As seen in reference to FIG. 1, the CPSSMS comprises six interoperable components, each programmed with empirical algorithmic machine learning (ML) enhanced by advanced techniques including: Advanced Predictive Modeling, Reinforcement Learning Integration, Feature Expansion with Unsupervised Learning, Dynamic Gradient Optimization, Enhanced Visualization Capabilities, Natural Language Processing (NLP), Scalable Distributed Computing, and Bias Mitigation and Explainability, to adaptively model staffing variables such as operational readiness, staff availability, overtime, and compliance as functions of multiple inputs. The GSCE oversees these functions, applying backpropagation for refinement and providing graph and 3D visualizations for actionable insights.

As seen in reference to FIG. 1, the CPSSMS 100 employs a suite of advanced tools which may include the following components: a Schedule Mapping Tool (SMT) 120; a Tour, Group, Squad Balance Calibration Tool 130; an Operative Daily Overtime Tracking Reporting Tool (ODOTRT) 105, an Enhanced Overtime Code Mapping (EOCM) Tool 140; an Overtime Tracking System (OTS) 150; a Governed System Compliance Engine (GSCE) 170; and a Sequential Staff Sort System (SSSS) 160 to ensure jurisdictional compliance, operational efficiency, and fiscal sustainability.

As indicated, by embedding advanced ML techniques into each function to adaptively model staffing as multi-variable systems, refined through backpropagation, and visualized via graph and 3D analytics, the CPSSMS 100 delivers a dynamic, data-driven framework to address the complexities of carceral institutions, aligning workforce orchestration with constitutional mandates and modern governance principles.

By integrating data from various sources such as organizational tables, staff rosters, and overtime records, the CPSSMS 100 may provide corrections administrators with a more comprehensive view of their staffing situation. The system may employ advanced analytical techniques to process this data and generate insights that can inform staffing decisions.

In some cases, the CPSSMS 100 may assist in creating authorized staff schedules, balancing staff assignments across different tours and squads, tracking and forecasting overtime needs, calculating full-time equivalent staffing requirements, and assigning staff to rosters while considering factors such as seniority and contractual obligations.

The CPSSMS 100 may also include mechanisms for visualizing staffing data and compliance metrics, potentially allowing administrators to more easily identify trends, gaps, or areas requiring attention. Through its various components, the CPSSMS 100 aims to enhance operational efficiency, maintain adequate staffing levels, and support compliance with relevant standards in corrections facilities.

In further reference to FIG. 1, the system architecture for the CPSSMS 100 may include multiple interconnected components designed to manage staffing in corrections facilities. A schedule mapping module 101 may receive inputs from an organization data extraction module 102. The organization data extraction module 102 may extract data from operative tables of organization for the corrections facility. A personnel administration module 103 may connect to a staff roster extraction module 104 which extracts staff roster information from personnel records.

The CPSSMS 100 may also include a Schedule Mapping Tool 120 that receives inputs from the schedule mapping module 101. The Schedule Mapping Tool 120 may generate a new structured schedule based on the extracted organizational data, as further described below.

A Squad Balance Tour, Group, Squad Balance Calibration Tool 130 may interface with the Schedule Mapping Tool 120 and an Overtime Tracking Module (OTM) 150. The OTM 150 may collect and process overtime data from the corrections facility. The OTM 150 may feed data into an Enhanced Overtime Code Mapping Tool (EOCMT) 140, which may connect to an Overtime Tracking System 140. These components may work together to analyze and manage overtime patterns within the facility.

A Sequential Staff Sort System (SSSS) 160 may process data from both the staff roster extraction module 104 and the Squad Balance Tour, Group, Squad Balance Calibration Tool 130. This system may assist in organizing and assigning staff to various positions and shifts.

The Governed System Compliance Engine (GSCE) 170 may monitor and validate the outputs from the various system components. The GSCE 170 engine may ensure that staffing decisions and allocations comply with relevant jurisdictional standards and regulations.

In some cases, the system architecture for CPSSMS 100 may utilize distributed computing frameworks such as TensorFlow or PyTorch for processing large-scale data across multiple corrections facilities. These frameworks may enable efficient analysis and management of staffing data from various sources within the CPSSMS 100.

The components of the CPSSMS 100 may be arranged in a hierarchical flow, with data and information passing between modules through connecting pathways. This integrated approach may enable comprehensive staffing management functions including scheduling, roster management, overtime tracking, and compliance monitoring within a unified framework.

As will be appreciated, the CPSSMS 100 provides budgetary data tools, programing, and a governing database that addresses long term goals, current fiscal challenges, and operational constraints with solid operational principles, functionalities, detailed visualizations, tools, and applications to move towards optimizing organizational sustainability in a fiscally prudent and effective manner. The CPSSMS also provides predictive analytics to assess long term fiscal outlooks of operations for future budgetary planning with advanced forecast capabilities.

The CPSSMS 100 provides tools to assure budgetary fitness with robust operational efficiencies for managing organizational performance as they are evolved to meet the societal needs of today. A mapping system provides effective methodologies for assisting organizations in the codification of government administration as it pertains to the management of domestic public safety organizations within the American criminal justice system with effective organizational management and long term fiscal sustainability.

Aspects of the CPSSMS 100 deliver a digital dashboard to monitor staff management and compliance with jurisdictional statutory authority, rules and regulations and codes, and ordered consent decree judgments, collectively jurisdictional guidelines. The CPSSMS 100 is a systems tool designed to advise and assist in achieving compliance as a neutral third-party compliance consultancy service. The CPSSMS 100 provides a method for effectively enforcing staffing levels to maintain humane conditions and constitutional standards of confinement that promote the general welfare of individuals held within an institutional jail or prison settings.

The CPSSMS 100 provides qualitative data modules, sound data integration, and a unified data governance in the mapping and deployment of personnel. The CPSSMS 100 personnel administration module 103 empowers command and staff with effective managerial methodologies and artificial intelligence in the segmentation, classification, feature extraction, and post-processing of data. The CPSSMS 100 provides a system for sculpting change with a creative innovative technology solution and lifecycle service orchestration that provide long-term sustainability and compliance.

The various tools of the CPSSMS 100 provide longitudinal data measuring staffing levels; volume of overtime, and trending trajectories of each measure per member of service by positional rank. The CPSSMS tools validate structured overtime governance to ensure effective staffing levels are maintained to perform duties according to job descriptions and operational demands. Forecasts for budgetary gaps, operative overtime requirements, and ramp-up times for the appropriation of funding for salaries and fringe benefits for the onboarding of new personnel are also provided.

Elements of the system provide reports to measure staffing fatigue rates and overtime limitations based on threshold set by said organizations and in accordance with applicable jurisdictional statutory authority, rules and regulations and codes of full coverage factor requirements of manning formulations for government administrative agencies and privately operated organizations subject to said statutory authority, rules and regulations and codes within governmental jurisdictions. Requirements to all of which are system rules and safeguards to employ staffing levels as necessary to provide care, custody, and control of inmates in a safe and effective environment in accordance with the law.

Staffing tools provide the capability to evolve operations and right size staffing levels to fulfill organizational transitions. Whether it is through the introduction of new programs, classifications, new facilities or any other factors, including those unique to a particular existing facility.

The CPSSMS 100 delivers predictive data analytics on staffing patterns and frequencies, providing an in-depth analysis of staffing assumptions and methodologies for productivity savings towards future collective bargaining agreements.

The CPSSMS 100 also provides validation of operative tables of organization, to ensure they are complete in detail and composition in providing authorized post counts and manning formulations as necessary to provide budgeted personnel services of each facility function during each shift regularly scheduled within 24 hours, in accordance with jurisdictional rules and regulation, codes, statutory guidelines and court ordered consent decrees.

The CPSSMS 100 delivers effective methodologies in the management of budgeted manning formulation personnel services. Flagging operative variations that exceed budgeted unit appropriation within personnel services for the evaluation of cause and effect of said events and to ascertain the need for additional personnel services necessary to meet minimum facility staffing requirements. In accordance with applicable jurisdiction full coverage factor statutory requirement.

The CPSSMS 100 delivers system data fabric that establish data management architecture, providing resilient integration of data sources across platforms and users, making data available where it is required within an organization.

### Schedule Mapping Tool

The Schedule Mapping Tool (SMT) 120 incorporated the digital integration of data from operative agency tables of organization authorized staffing levels by positional rank, tours, and days of operation. The SMT 120 provides qualitative data for the strategic mapping of all personnel operating within authorized positional requirements. The SMT 120 creates an architecturally structured authorized staff work schedule 120 based on authorized staffing levels and jurisdictional requirements of each facility, post, days, and tours of operation.

The Schedule Mapping Tool 120 transforms organizational data management systems, from manual-entry dependency and non-integrated systems, to a digitally integrated system governed by system compliance models within the Governed System Compliance Engine 170 managing all Schedule Mapping Tool 120 functionality requirements and entire systems lifecycle. The GSCE 170 is interfaced and centralized from one master table to each individual command end user 110, 155 making data available where it is required. In accordance with each organization's specification and protocols i.e. personnel, command staff, requiring approval and validation when posted for use.

Operative tables of organization are detailed in composition to provide authorized post counts and manning formulations as necessary to provide budgeted personnel services of each facility function during each shift regularly scheduled within 24 hours, in accordance to jurisdictional rules and regulation, codes, statutory guidelines and court ordered consent decrees.

Examples of a budgeted unit appropriations within manning formulation for personnel services are shown in the following Table I:

| | |
|---|---|
| General facility administration | Control room operation |
| and management | |
| General housing area supervision | Special housing area supervision |
| Medical services | Visitation |
| Correspondence | Recreation \| Exercise |
| Facility maintenance | Library \| Law library |
| Commissary | Religious services |
| Prisoner transportation | Any additional required program |
| | orservice |

Example of personnel service manning formulation is shown in the following Table II.

TABLE II

| | | Number of days based |
|---|---|---|
| Reason for | | on staff manning |
| Absence | Description | formula |
| Pass Days | Difference between calendar | 104.00 |
| | year (365 days) and contractual | |
| | appearance rate (261 days). | |
| Chart Days | Compensation days earned | 20.00 |
| | based on contractual 8-hour | |
| | days, but actual working longer | |
| | workdays i.e.; 8 hrs 30 minutes | |
| | 8 hrs 15 minutes | |
| Sick Days | Sick leave rate fiscal year | 12.00 |
| | average | |
| Miscellaneous | Includes jury duty, maternity | 2.00 |
| Days | leave, AWOL, funeral | |
| | leave, military leave, and | |
| | death in the family, fiscal | |
| | year average | |
| Vacation Days | vacation usage according to | 16.00 |
| | contractual obligations | |
| Training Days | annual in-service training | 5.00 |
| | Total Personnel Service | 159 |
| | Absences | |
| | Operating Days (A) | 365 |
| | Total Personnel Service | 159 |
| | Absences (B) | |
| | Appearance Rate in Days | 206 |
| | (A − B) | |
| | FTE for One Post for 365 Days | 1.772 |
| | [A/(A − B)] | |

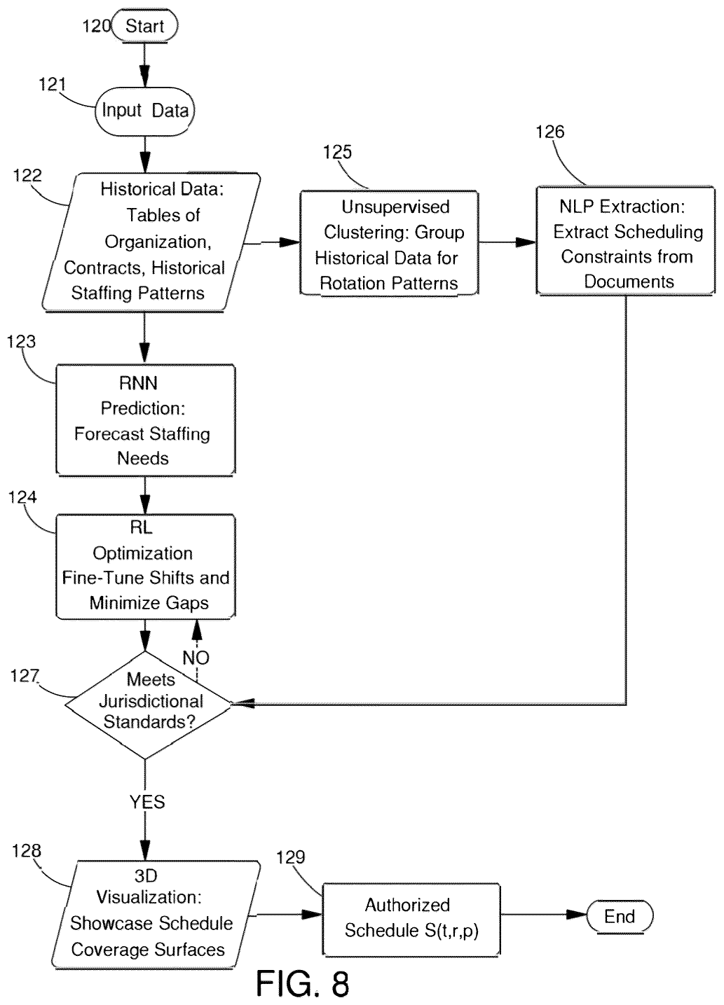

A flowchart illustrating an implementation of the Schedule Mapping Tool 120 is shown in reference to FIG. 8. As indicated previously, the Schedule Mapping Tool 120 creates an architecturally structured authorized staff work schedule based on data extraction from the operative table of organization.

The Schedule Mapping Tool 120 may begin by receiving input data 121. In some cases, the input data 121 may include information from the organization data extraction module 102 and the schedule mapping module 101. The Schedule Mapping Tool 120 may then gather and import historical data 122, which may include tables of organization, contracts, and historical staffing patterns.

The Schedule Mapping Tool 120 may utilize a recurrent neural network (RNN) prediction 123 component for forecasting staffing needs. The RNN prediction 123 may analyze temporal patterns in the historical data to predict future staffing requirements, accounting for factors such as seasonal variations or recurring events that impact staffing levels.

To optimize shift schedules, the Schedule Mapping Tool 120 may incorporate a reinforcement learning (RL) optimization 124 component. The RL optimization component 124 may learn from real-time feedback and historical outcomes to adjust shift assignments, aiming to minimize gaps in coverage while balancing staff preferences and operational requirements.

After importing the historical data 122, the Schedule Mapping Tool 120 may employ multiple analytical techniques to process and optimize the scheduling information. In a parallel pathway, an unsupervised clustering 125 component may group historical data to identify optimal rotation patterns. This unsupervised clustering 125 may help reveal underlying patterns in staffing needs and preferences across different time periods and facility areas.

A natural language processing (NLP) extraction 126 component may parse scheduling constraints from documents such as policies, regulations, or union agreements. By extracting and interpreting these constraints, the Schedule Mapping Tool 120 may ensure that generated schedules comply with relevant rules and requirements.

The Schedule Mapping Tool 120 may include a decision point to determine jurisdictional compliance 127 to evaluate whether the generated schedule meets applicable standards and regulations. The jurisdictional compliance decision point 127 evaluates compliance using the integral ∫S(t, r, p)dt, where t represents time, r represents rank, and p represents post. When the jurisdictional compliance standards are not met, the process may loop back to the RL optimization component 124 for further optimization.

When jurisdictional compliance is achieved, the Schedule Mapping Tool 120 may generate a 3D visualization 128 to showcase schedule coverage surfaces. The visualization 128 may help administrators identify potential gaps or imbalances in staffing across different time periods and facility areas.

The Schedule Mapping Tool 120 may conclude by producing an authorized schedule S(t, r, p) 129. This authorized schedule may serve as the basis for subsequent staffing management processes within the Constitutional Public Safety Staff Management System.

### Tour, Group, Squad Balance Calibration Tool

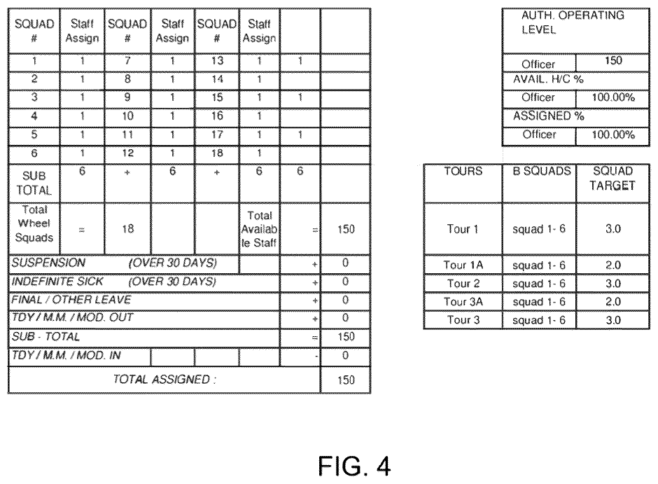

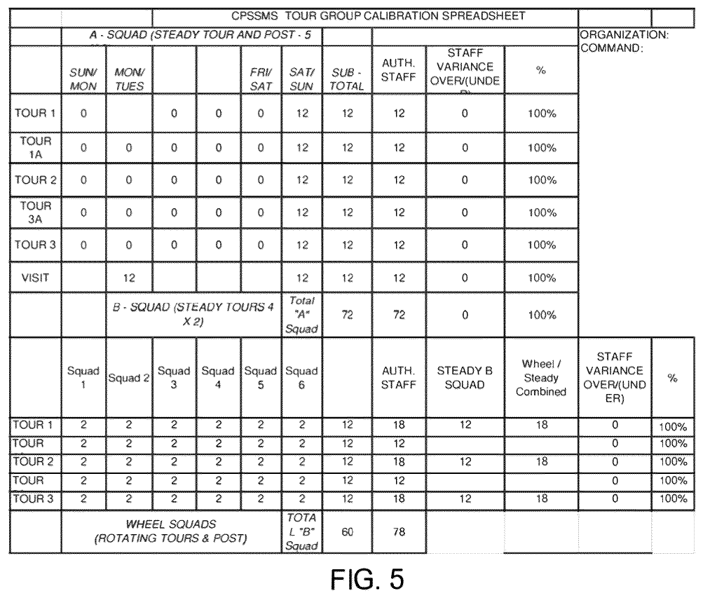

The Tour, Group, Squad Balance Calibration Tool 130, shown integrates with data from the Schedule Mapping Tool 120. The Tour, Group, Squad Calibration tool 130 is shown in reference to FIGS. 4 and 5. The Tour, Group, Squad Calibration tool 130 provides a mapping system of authorized, actual, and available staff against authorized position requirements by positional ranks for each shift, tour group, and rotations, such as “4×2 rotations” or “5×2 rotations”. The authorized position requirements are provided by each organization's authorized operative table of organization specifications by command. The organization data extraction module 102 extracts authorized position data from each organization's table of organization, employing multiple measurement indicators providing data management and governance of staffing variances “deficits and surpluses” per each shift, tour group, and rotation for proper staffing calibration and squad reconciliations.

Data quantifications of the Tour, Group, Squad Balance Calibration Tool 130 may be mapped longitudinally to provide methodologically predictive forecasts tracking staffing level trajectories to support organizational decisions; addressing impending staffing shortages, and staff onboarding requirements for future personnel to maintain operational continuity and budgetary fitness. The Tour, Group, Squad Balance Calibration Tool 130 transforms organizational data management systems, from manual-entry dependency and non-integrated systems to fully digital integrated and governed system models, capable of managing all tour group functionality requirements and entire systems lifecycle.

In summary, the Tour, Group, Squad Balance Calibration Tool 130 provides each command with:
Command authorized operating level;
Authorized staffing levels by tour group and rotation;
Available total staff assigned;
Individual squad group totals and sub-totals of all squads by tour and rotation;
Squad percentages by tour group and rotation;
Squad target levels by tour group and rotation;
Squad staff variance over/under per tour group;
Total of unavailable staff i.e.; indefinite sick, final leave/other leave; and
Total of temporary duty assignments, medically monitored, modified duty membersassigned in command and members assigned out of command.

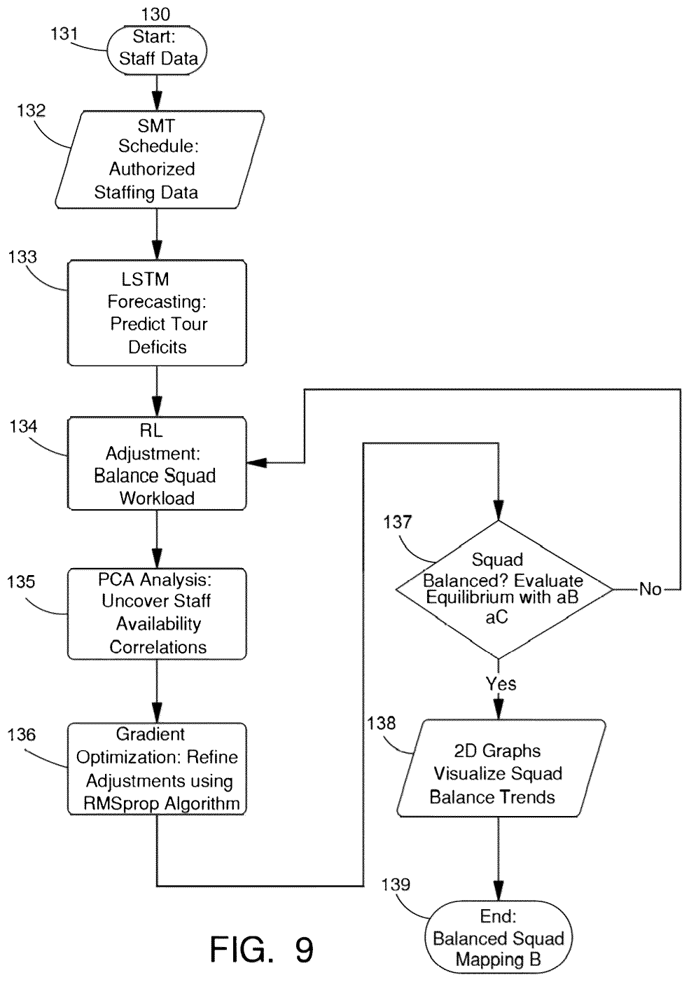

The Tour, Group, Squad Balance Calibration Tool 130 may provide a mapping of authorized, actual, and unavailable staff against authorized position requirements specified in the validated architecturally structured authorized work schedule. FIG. 9 illustrates a flowchart of the Tour, Group, Squad Balance Calibration Tool 130 process.

The Tour, Group, Squad Balance Calibration Tool 130 may begin by receiving staff data 131. In some cases, the staff data 131 may include information from the personnel administration module 103 and the staff roster extraction module 104. The Tour, Group, Squad Balance Calibration Tool 130 may then process an SMT Schedule 132, which may contain authorized staffing data from the Schedule Mapping Tool 120.

From the SMT Schedule 132, the Tour, Group, Squad Balance Calibration Tool 130 may employ multiple analytical techniques to process and optimize the staffing information. A Long Short-Term Memory (LSTM) Forecasting component 133 may predict one or more tour deficits. The LSTM Forecasting component 133 may analyze temporal patterns in the staffing data to forecast potential shortages or surpluses across different tours and shifts.

To balance squad workload, the Tour, Group, Squad Balance Calibration Tool 130 may incorporate a Reinforcement Learning (RL) Adjustment 134 component. The RL Adjustment 134 may learn from historical outcomes to adjust squad assignments, aiming to distribute workload evenly while maintaining operational requirements.

A Principal Component Analysis (PCA) 135 may uncover staff availability correlations. By applying the PCA 135, the Tour, Group, Squad Balance Calibration Tool 130 may identify underlying patterns and relationships in staff availability data, potentially revealing factors that influence staffing levels across different tours and squads.

The Tour, Group, Squad Balance Calibration Tool 130 may include a Gradient Optimization 136 step to refine adjustments. In some cases, the Gradient Optimization 136 may use the RMSprop algorithm to enhance the accuracy and efficiency of staff balance calculations.

A Determine Squad Balance 137 step may evaluate whether the generated squad assignments achieve the desired balance. If the balance is not achieved, the process may loop back to the RL Adjustment 134 for further optimization.

When squad balance is achieved, the Tour, Group, Squad Balance Calibration Tool 130 may generate a 2D Squad Balance Visualization 138. This visualization may help administrators identify potential imbalances in staffing across different squads and tours.

The Tour, Group, Squad Balance Calibration Tool 130 may conclude by producing a Balanced Squad Mapping 139. This mapping may serve as the basis for subsequent staffing management processes within the Constitutional Public Safety Staff Management System.

In some cases, the Tour, Group, Squad Balance Calibration Tool 130 may provide data management and governance of staffing variances. FIG. 4 and FIG. 5 illustrate examples of how the tool may track and visualize these variances. The tool may calculate and display metrics such as authorized operating levels, available headcount percentages, and squad targets for different tours.

By integrating advanced analytical techniques such as LSTM forecasting and PCA, the Tour, Group, Squad Balance Calibration Tool 130 may enable more accurate prediction of staffing needs and identification of staffing patterns. This approach may allow corrections facilities to proactively address potential staffing imbalances and optimize resource allocation across different tours, groups, and squads.

### Enhanced Overtime Code Mapping Tool

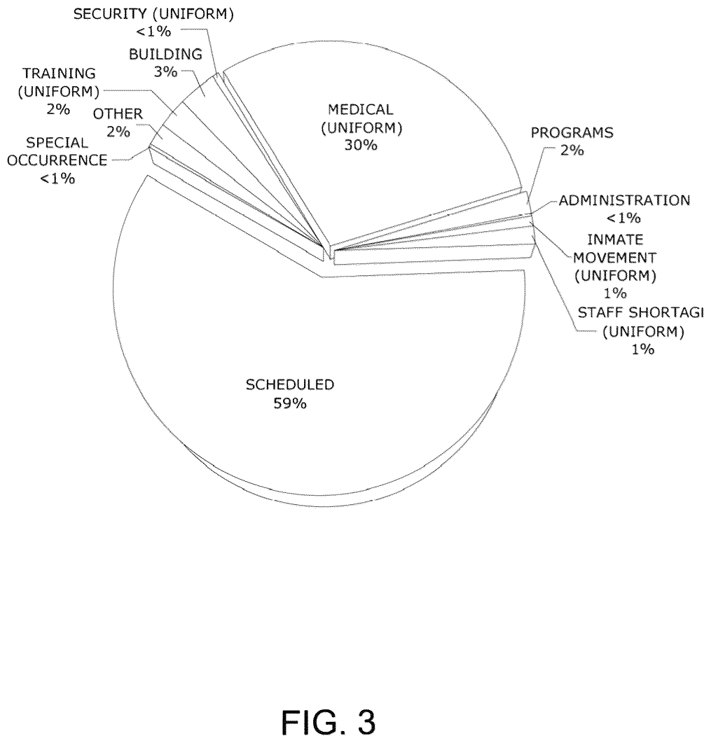

The Enhanced Overtime Code Mapping Tool 140 presents systematic algorithms and actualizations of staff overtime, measuring the exact number of operative personnel to staff a jail or prison system. As seen in reference to FIG. 3, the Enhanced Overtime Code Mapping Tool 140 provides detailed data granularity, forensic digital threading, and forecast capabilities to provide safe and effective staff management in conformance with each organization's jurisdictional guidelines. The Enhanced Overtime Code Mapping Tool 140 includes two components.

Data for the Enhanced Overtime Code Mapping Tool 140 may be Integrated from the Schedule Mapping Tool 120 and from Operative Organizational Daily Overtime Tracking Reports 130, as posted, providing real time qualitative data synthesis, matching each organizations overtime code systems specifications.

During initial data integration, an analysis of operative organizational overtime tracking systems is conducted, ensuring full data traceability and logical data pathways for digital threading in accordance to applicable jurisdictional requirements and guidelines. The Enhanced Overtime Code Mapping Tool 140 transforms organizational data management systems from manual-entry dependency and non-integrated systems to fully digital integrated and governed system models, managing all Enhanced Overtime Code Mapping 140 functionality requirements and systems lifecycle.

The first component for the Enhanced Overtime Code Mapping Tool 140 provides measures of full coverage factor requirements of manning formulations representative of a full-time equivalent of personnel headcount by positional rank, the salary hours of coverage provided by said full-time equivalent headcount, and “in-budget” hours of overtime incurred due to staffing gaps. The full-time equivalent is determined in accordance with applicable jurisdictional statutory authorities, rules and regulations, and codes of a full coverage factor requirement of manning formulations for government administrative agencies and privately operated organizations subject to said applicable statutory authority, rules and regulations, and codes within governmental jurisdictions.

The full coverage factor requirement may be presented in hours, percentage, and monetary levels, for a daily, a monthly, a quarterly and a fiscal year. The full coverage factor requirement may be categorized as “in-budget” providing numerical values of full-time equivalent (per officer by positional rank) and percentage of staff required to absorb said “in-budget” overtime, as categorized by one or more overtime codes and sub-groups within said one or more overtime codes categories.

By way of non-limiting example, code quantifications of the first component categorized as “in-budget” of jurisdictional full coverage factor requirements of manning formulation of daily staffing requirements may be flagged as significant once they exceed 2.5% percent of a total unit appropriation authorized of manning formulations for said budgeted personnel service within each position rank. Said actions create a mechanism for the evaluation of the cause and effect of said events and to ascertain the need for additional personnel services necessary to meet minimum facility staffing requirements in accordance to applicable jurisdiction full coverage factor statutory requirements.

The second component for Enhanced Overtime Code Mapping Tool 140 provides measures of the full coverage factor requirements of manning formulations representative of the full-time equivalent of uniform personnel headcount overtime incurred due to facility added post and emergency events outside of a budgeted headcount. The measures are determined in accordance with jurisdictional statutory authority, rules and regulations and codes of full coverage factor requirements of manning formulations for government administrative agencies and privately operated organizations subject to said statutory authority, rules and regulations and codes within governmental jurisdictions. The measures may be presented in hours, percentage, and/or monetary levels, for daily, monthly, quarterly and fiscal year and categorized as “out-of-budget” providing numerical values of full time equivalent (per officer by positional rank) and percentage of staff required to absorb “out-of-budget” overtime.

Code quantifications of the second component categorized as “out-of-budget”, that is, outside of the budgeted head count are quantified daily and flagged as significant once they exceed 2.5% percent of staffing levels within each position rank. These actions create a mechanism for the evaluation of the cause and effect of said events and to ascertain the need for additional personnel services necessary to meet minimum facility staffing requirements in accordance with the applicable jurisdiction full coverage factor statutory requirement.

As seen in FIG. 3, Enhanced Overtime Code Mapping Tool 140 can provide the following measures:
Code quantifications of overtime due to facility added post activations, may be flagged once they manifest to ensure adherence to jurisdictional guidelines;
Code quantifications due to non-coverage of post by personnel, classified as an unmanned post and flagged once they manifest as a manning deficit to ensure adherence with jurisdictional guidelines;
Code quantifications due to post shift reductions, may be classified as a post closure and flagged once they manifest to ensure adherence with jurisdictional guidelines; and
Code quantifications of components one and two may be mapped longitudinally with a stacked bar charts and/or pie charts providing overtime trends, methodologically predictive forecasts, and drill down reports to support organizational decisions and budgetary fitness by measuring the quantification of both in-budget and out-of-budget overtime activity.

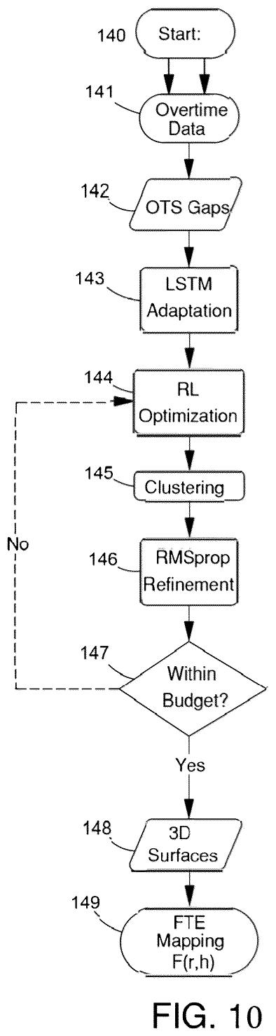

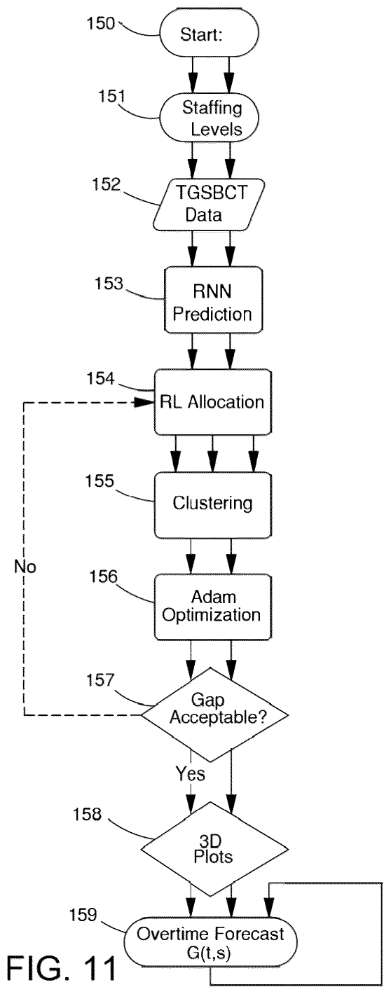

As indicated previously, the system architecture for CPSSMS 100 may include the Enhanced Overtime Code Mapping Tool (EOCMT) 140. The EOCMT process is illustrated in the flow chart of FIG. 10. The EOCMT 140 may begin by receiving overtime data 141. In some cases, the overtime data 141 may include information from the overtime tracking module 105. The EOCMT 140 may then process OTS gaps 142, which may contain hours, anomalies, and costs information from the Overtime Tracking System 140.

From the OTS gaps 142, the EOCMT 140 may employ multiple analytical techniques to process and calculate full-time equivalent (FTE) headcount. A Long Short-Term Memory (LSTM) adaptation 143 component may adapt FTE estimates to anomalies. The LSTM adaptation 143 may analyze temporal patterns in the overtime data to adjust FTE calculations based on unexpected events or emergencies that impact staffing requirements.

To optimize FTE allocation, the EOCMT 140 may incorporate a reinforcement learning (RL) Optimization 144 component. The RL Optimization component 144 may learn from historical outcomes to adjust FTE assignments, aiming to minimize out-of-budget overtime while maintaining operational requirements.

A clustering 145 component may detect cost drivers in the overtime data. By applying clustering 145, the EOCMT 140 may uncover underlying patterns and relationships in overtime costs, potentially revealing factors that influence FTE requirements across different positions and facility areas.

The EOCMT 140 may include an RMSprop Refinement 146 to enhance cost accuracy. In some cases, the RMSprop Refinement 156 may improve the precision of FTE calculations and budget estimations.

A Within Budget Determination 147 may evaluate whether the calculated FTE requirements are within budgetary constraints. When the FTE requirements exceed the budget constraints, the process may loop back to the RL Optimization 144 for further refinement.

When budget compliance is achieved, the EOCMT 140 may generate 3D surfaces 148. These 3D surfaces 148 may display FTE needs versus budget, helping administrators visualize the relationship between staffing requirements and financial resources across different dimensions such as rank and hours.

The EOCMT 140 may conclude by producing an FTE mapping F(r, h) 149, where r represents rank, and h represents hours. This FTE mapping may serve as the basis for subsequent staffing and budgetary decisions within the Constitutional Public Safety Staff Management System.

In some cases, the EOCMT 140 may measure full coverage factor requirements of manning formulations. These measurements may be presented in hours, percentage, and monetary levels, for daily, monthly, quarterly, and fiscal year periods. The EOCMT 140 may categorize overtime as “in-budget” or “out-of-budget” based on predefined criteria.

For “in-budget” overtime, the EOCMT 140 may provide numerical values of full-time equivalent per officer by positional rank and percentage of staff required to absorb the overtime. This categorization may be based on one or more overtime codes and sub-groups within those code categories.

For “out-of-budget” overtime, the EOCMT 140 may calculate full-time equivalent headcount and percentage of staff required to cover overtime incurred due to facility added posts and emergency events outside of the budgeted headcount.

By integrating advanced analytical techniques such as LSTM adaptation 143 and RL optimization 144, the EOCMT 140 may enable more accurate calculation of FTE requirements and optimization of overtime allocation. This approach may allow corrections facilities to better manage staffing resources and budget constraints while maintaining operational effectiveness.

### Overtime Tracking System (OTS)

The Overtime Tracking System 150 tracks the volume of staff overtime and trajectories of overtime per members of service by positional rank and command, mapping minimum staffing requirements for each facility, by tour group and rotation. Overtime Tracking System 150 provides real-time data and predictive forecasts of operative overtime requirements to manage ramp-up scheduling for the appropriation of funding and onboarding of new personnel. The governance of said system shall be centralized from one master table to each facility end user, making data available where it is required, in accordance to each organization's specification and protocols i.e. personnel, command staff.

The Overtime Tracking System 150 integrates data from the Schedule Mapping Tool 120 and the Enhanced Overtime Code Mapping Tool (EOCMT) 140. Data may be quantified by overtime hours as scaled by changes in staffing availability. Overtime reports 130 may be generated daily, weekly and monthly.

The methodology measures operational gap in hours between available staff and a minimum facility staffing requirement for each facility to be performed by each shift, tour, group, and rotation, regularly within a 24-hour period. In essence, the OTS 150 quantifies operational gaps over time, as represented in the following equation.

$$G ( t , s ) = A ( t , s ) - C ( t , s ) .$$

The Overtime Tracking System 150 may receive Staffing Levels 151 data and TGSBCT Data 152 from the Squad Balance Tour, Group, Squad Balance Calibration Tool 130. The Overtime Tracking System 150 may use Recurrent Neural Network (RNN) Prediction 153 and Reinforcement Learning (RL) Allocation 154 to forecast and optimize overtime needs. The system may employ Clustering 155 and Adam Optimization 156 to identify patterns and refine predictions. The GAP Acceptability Determination 157 may evaluate whether predicted overtime gaps are within acceptable limits.

The Enhanced Overtime Code Mapping Tool (EOCMT) 140 may process overtime data 151 and OTS gaps 152 from the Overtime Tracking System 140. The EOCMT 140 may use the LSTM adaptation 153 and the RL Optimization 154 to calculate and optimize full-time equivalent (FTE) headcount requirements. The tool may employ clustering 155 and RMSprop Refinement 156 to enhance cost accuracy. The Within Budget Determination 157 evaluates whether FTE requirements are within budgetary constraints.

The Overtime Tracking System 150 may be mapped longitudinally to provide methodologically predictive forecasts that support organizational decisions and budgetary fitness. Overtime Tracking System 150 measures overtime quantifications and staffing fatigue rates, due to both in-budget overtime activity and out-of-budget activity providing staffing safety baselines to map out daily, weekly and monthly overtime targets. Transforming organizational overtime data management systems, from manual-entry dependency and non-integrated systems, to digitally integrated governed system models managing all Overtime Tracking System 150s functionality requirements and entire systems lifecycle.

### Sequential Staff Sort System

A Sequential Staff Sort System 160 may process data from both the staff roster extraction module 104 and the Tour, Group, Squad Balance Calibration Tool 130. The SSSS 160 may assist in organizing and assigning staff to various positions and shifts.

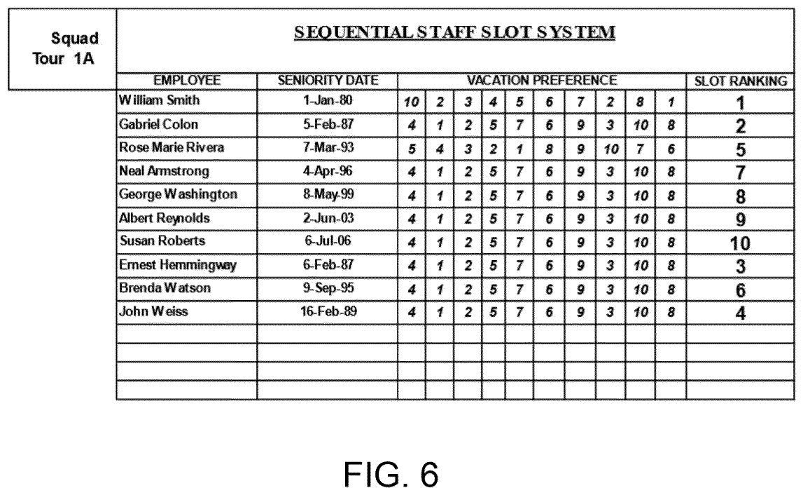

The Sequential Staff Sort System 160, shown in FIG. 6, employs multiple measurement indicators, providing digital integration of data management systems governing the process of staffing positions by seniority, tour, group, and rotation. The SSSS 160 integrates data from Schedule Mapping Tool 120 and the Tour, Group, Squad, Balance Calibration Tool 130. Utilizing the SSSS 160, staff rosters 160 are strategically structured to meet each organization's supply and demand of personnel services according to authorized Schedule mapping tool 120 specifications, maintaining operational continuity and compliance in the administrative management of staff, platoon, or group rosters by tour, group, and rotation for scheduling of contractual fringe benefits i.e. vacation picks selections, post awards, and employee data in accordance to each organizations' specification. The SSSS 160 ensures appearances by assigned staff are made uniformly across days and tours, eliminating asymmetrical staffing patterns that are inconsistent with operative organizational tables of organization.

The Sequential Staff Sort System 160 transforms organizational data management systems, from manual-entry dependency and non-integrated systems, to digitally integrated and governed system compliance models, managing all functionality requirements and entire systems lifecycle. The SSSS 160 may be utilized to sort staff with composite listing reports to include:
Employee name by command;
Employee seniority date and list number by command;
Employee vacation preference in slot ranking order 1st choice to 10th choice.
Vacation slots awarded as categorized, fiscally according to binding contractual agreements by command;
Employee tour group, i.e. tour 1, tour 1A, tour 2, tour 3A, tour 3 and rotation, i.e. “4×2 rotation, 5×2 rotation” by command;
Employees on terminal leave shall have their vacation slots awarded in according to seniority within first slots of available vacation picks by command;
Dates of employee statutory and ancillary training certifications by command; and
Additional employee data in accordance with each organizations' specification.

The SSSS 160 may process Staff Records 161 and contract data 162 to generate optimal roster assignments. The SSSS 160 may use a recurrent neural network (RNN) prediction component 163 and reinforcement learning (RL) assignment component 164 to forecast staff availability and optimize assignments. The SSSS 160 may employ clustering 165 and an Adam Optimization 166 to refine predictions and assignments. The Coverage Uniformity Determination 167 may evaluate whether generated roster assignments achieve desired balance and coverage.

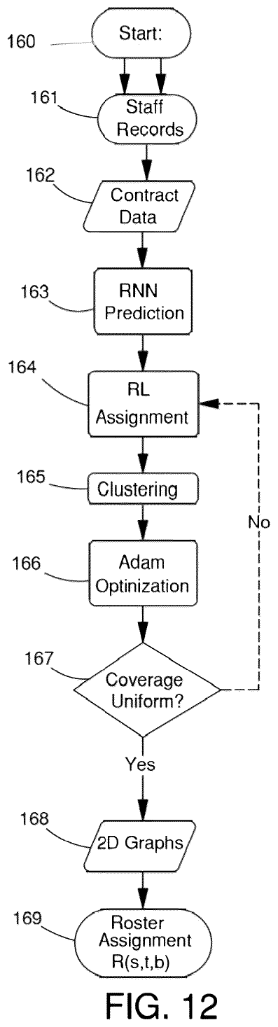

A flowchart of the Sequential Staff Sort System (SSSS) 160 process is shown in reference to FIG. 12. The SSSS 160 process may begin by collecting Staff Records 161. In some cases, the Staff Records 161 may include information from the personnel administration module 103 and the staff roster extraction module 104. The SSSS 160 may then assess contract data 162, which may provide information about personnel availability, preferences, and benefits.

From the contract data 162, the SSSS 160 may employ multiple analytical techniques to process and optimize staff assignments. An recurrent neural network (RNN) prediction component 163 may predict staff availability. The RNN prediction component 163 may analyze temporal patterns in the staff data to forecast potential availability across different shifts and time periods.

To optimize roster assignments, the SSSS 160 may incorporate the RL assignment component 164. The RL assignment component 164 may learn from historical outcomes to adjust roster assignments, aiming to balance staff preferences and operational requirements while maintaining continuity in staff, platoon, or group assignments.

A clustering 165 component may process staff data to identify patterns and groupings. By applying clustering 165, the SSSS 160 may uncover underlying relationships in staff characteristics, potentially revealing factors that influence optimal roster assignments.

The SSSS 160 may include an Adam Optimization 166 to refine predictions. In some cases, the Adam Optimization 166 may enhance the accuracy and efficiency of staff availability forecasts and roster assignments. The SSSS 160 may also use use SHAP (SHapley Additive explanations), which helps in understanding how different input features influence the output, ensuring fairness and transparency in model predictions, and in this instance, fair roster assignments.

The coverage uniformity determination 167 may evaluate whether the generated roster assignments achieve the desired balance and coverage. If the coverage is not uniform, the process may loop back to the RL assignment component 164 for further optimization.

When uniform coverage is achieved, the SSSS 160 may generate 2D Graphs 168. These 2D Graphs 168 may display roster uniformity, helping administrators visualize the distribution of staff across different shifts and time periods.

The SSSS 160 may conclude by producing a Roster Assignment R(s, t, b) 169, where s represents staff, t represents time, and b represents benefits. This roster assignment 169 may serve as the basis for subsequent staffing management processes within the Constitutional Public Safety Staff Management System. The SSSS 160 may also apply the integral Integrals of R, ∫R(s, t, b) ds to balance allocation across shifts.

In some cases, the SSSS 160 may account for scheduling of contractual fringe benefits. Referring again to FIG. 6, the SSSS 160 may organize and manage staff assignments while considering factors such as seniority and vacation preferences. The system may track employee information, seniority dates, and ranked vacation slot preferences to generate final slot rankings that balance individual preferences with operational needs.

By integrating advanced analytical techniques such as the RNN prediction component 163 and RL assignment 164, the SSSS 160 may enable more accurate forecasting of staff availability and optimization of roster assignments. This approach may allow corrections facilities to maintain operational continuity while accommodating staff preferences and contractual obligations.

### The Governed System Compliance Engine (GSCE)

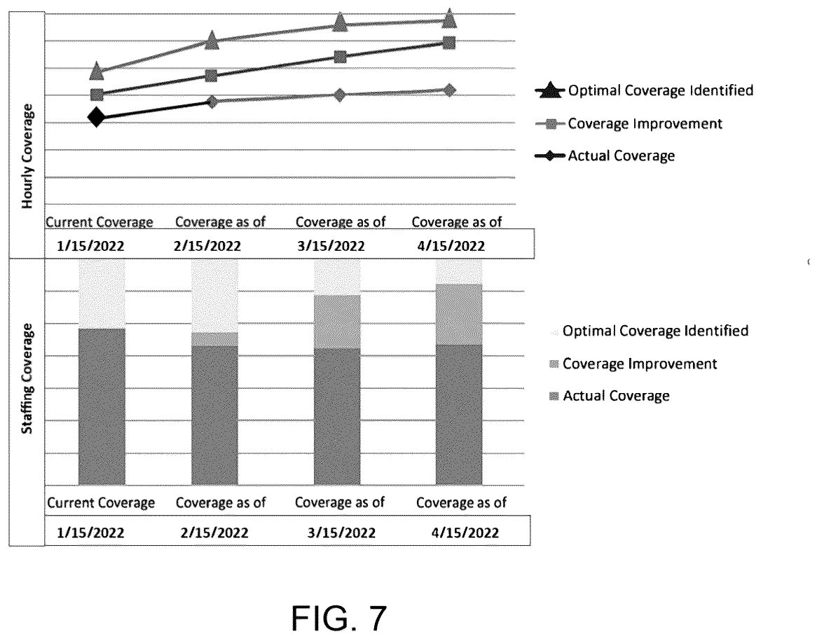

The Governed System Compliance Engine 170 of the CPSSMS monitors compliance with jurisdictional statutory authority, rules and regulations, and codes for determining compliance with requirements of manning formulations and contractual compliance of personnel services for government administrative agencies and privately operated organizations subject to said statutory authority, rules and regulations and codes within governmental jurisdictions. The Governed System Compliance Engine 170 provides visualization tools, such as seen in FIG. 7 for presentation of historical and/or prospective tracking with compliance standards, expressed as an optimal coverage level, against an actual coverage, and a coverage improvement along a selected temporal period.

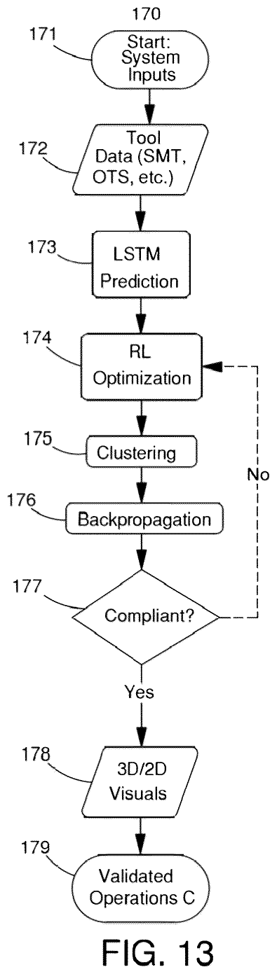

The system architecture for CPSSMS 100 may include a Governed System Compliance Engine (GSCE) 170. FIG. 13 illustrates a flowchart of the Governed System Compliance Engine (GSCE) 170 process.

The Governed System Compliance Engine (GSCE) 170 may begin by receiving system inputs 171. In some cases, the system inputs 171 may include data from various components of the Constitutional Public Safety Staff Management System, such as the SMT 120, the Squad Balance Tour, Group, Squad Balance Calibration Tool 130, the Overtime Tracking System (OTS) 10, and the Enhanced Overtime Code Mapping Tool (EOCMT) 140. The Governed System Compliance Engine (GSCE) 170 may then process tool data 172, which may contain aggregated information from these various system tools.

From the tool data 172, the Governed System Compliance Engine (GSCE) 170 may employ multiple analytical techniques to process and validate the architecturally structured authorized staff work schedule.

A Long Short-Term Memory (LSTM) recurrent neural network may be employed to seamlessly model problems with multiple input variables to predict compliance risks over time. LSTM Prediction 173 component may predict compliance risks over time. The LSTM Prediction 173 may analyze temporal patterns in the staffing and operational data to forecast potential compliance issues, accounting for factors such as staffing levels, overtime usage, and jurisdictional requirements.

To optimize compliance strategies, the Governed System Compliance Engine (GSCE) 170 may incorporate a reinforcement learning (RL) optimization component 174. The RL Optimization component 174 may learn from historical outcomes to adjust staffing and operational parameters, aiming to maintain compliance with jurisdictional standards while balancing operational efficiency.

A clustering 175 component may identify risk patterns in the compliance data. By applying clustering 175, the Governed System Compliance Engine (GSCE) 170 may uncover underlying relationships in compliance factors, potentially revealing systemic issues or trends that may impact adherence to jurisdictional standards.

The Governed System Compliance Engine (GSCE) 170 may include a Backpropagation 176 step to refine the system's parameters. In some cases, the Backpropagation 176 may use the Adam optimization algorithm to enhance the accuracy and efficiency of compliance predictions and optimizations. The Backpropagation 176 refines ML models by minimizing errors (e.g., compliance gaps), adjusting inputs 171 iteratively.

A “Compliant?” decision point 177 may evaluate whether the current staffing and operational parameters meet jurisdictional standards. If compliance is not achieved, the process may loop back to the RL Optimization component 174 for further refinement.

When compliance is achieved, the GSCE 170 may generate 3D/2D Visuals 178. These 3D/2D Visuals 178 may provide visualization tools for compliance tracking, helping administrators monitor adherence to jurisdictional standards over time and across different operational dimensions.

The GSCE 170 may conclude by producing Validated Operations 179. These Validated Operations 179 may represent the final, compliant staffing and operational parameters that meet jurisdictional standards while optimizing resource allocation.

In some cases, the GSCE 170 may incorporate bias mitigation and explainability techniques. For example, the system may use SHAP (SHapley Additive explanations) analysis to provide transparent explanations for compliance decisions and ensure fairness in staffing allocations across different demographic groups or facility areas.

FIG. 7 illustrates an example of how the Governed System Compliance Engine (GSCE) 170 may visualize compliance metrics over time. The graph includes both line and bar representations of coverage metrics, including Optimal Coverage Identified, Coverage Improvement, and Actual Coverage. This type of visualization may help administrators track progress towards compliance goals and identify areas requiring attention or improvement.

By integrating advanced analytical techniques such as LSTM prediction and reinforcement learning, along with bias mitigation and explainability methods, the Governed System Compliance Engine (GSCE) 170 may enable more accurate forecasting of compliance risks and optimization of staffing strategies. This approach may allow corrections facilities to proactively address potential compliance issues while maintaining operational efficiency and fairness in resource allocation.

The GSCE Validates schedules and operations as Compliance (S, R, G, L), where S represents schedules, R represents rosters, G represents gaps, and L represents legal requirements, managing the ML functions. Multivariable Calculus: Optimizes Compliance using gradients ∇C and partial derivatives ∂C/∂S. A natural language processing (NLPP) processes legal texts and other documentation to dynamically update compliance variables. The GSCE may be implemented for scalable distributed computing resources and may, for example, leverage PyTorch for multifacility compliance analysis.

In some cases, the CPSSMS 100 may use advanced visualization techniques to present data and insights from various components. By way of example, the Schedule Mapping Tool 120 may generate 3D visualizations to showcase schedule coverage surfaces. The Overtime Tracking System 150 may produce 3D Plots 158 to display overtime trajectories. The Enhanced Overtime Code Mapping Tool (EOCMT) 140 may create 3D surfaces 148 to visualize FTE needs versus budget. The Governed System Compliance Engine (GSCE) 170 may generate 3D/2D Visuals 178 to provide visualization tools for compliance tracking.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for jurisdictionally compliant staffing management within a corrections system, comprising:
a Tour, Group, Squad Balance Calibration Tool configured to receive staffing data and authorized schedule data for one or more corrections facilities within the corrections system;
a Long Short-Term Memory (LSTM) Forecasting component embedded within the Tour, Group, Squad Balance Calibration Tool, the LSTM Forecasting component configured to analyze temporal patterns in the staffing data to forecast one or more tour deficits across shifts and rotations within the one or more corrections facilities;
a reinforcement learning adjustment component configured to refine squad assignments based on historical staffing outcomes and predicted deficits;
a gradient optimization component configured to enhance an accuracy of one or more squad balance calculations;
a compliance evaluation module configured to determine whether an adjusted squad assignment meets jurisdictional staffing requirements for the one or more corrections facilities; and
a visualization interface configured to display squad balance metrics and staffing forecasts over a selected temporal period.

2. The system of claim 1, wherein the staffing data comprises authorized, actual, and unavailable staff counts by positional rank, shift, tour group, and rotation.

3. The system of claim 1, wherein the LSTM Forecasting component is configured to generate predictive outputs for staffing shortages and surpluses over daily, weekly, and monthly intervals.

4. The system of claim 1, wherein the reinforcement learning adjustment component iteratively updates the squad assignments to minimize workload imbalance and maintain operational continuity.

5. The system of claim 1, wherein the gradient optimization component applies RMSprop to refine the one or more squad balance calculations based on staffing availability correlations.

6. The system of claim 1, wherein the compliance evaluation module uses jurisdictional staffing thresholds extracted from operative tables of organization.

7. The system of claim 1, wherein the visualization interface generates 2D squad balance visualizations to highlight staffing variances across tours and shifts.

8. The system of claim 1, further comprising a Principal Component Analysis (PCA) component configured to identify correlations in staff availability data.

9. The system of claim 1, wherein the system produces a Balanced Squad Mapping that serves as input for subsequent staffing management processes.

10. The system of claim 1, wherein the compliance evaluation module triggers a feedback loop to the reinforcement learning adjustment component when squad balance is not achieved.

11. A system for forecasting and optimizing full-time equivalent (FTE) staffing requirements in a corrections facility, comprising:
an Enhanced Overtime Code Mapping Tool configured to receive overtime data and operational gap data from an Overtime Tracking System;
a Long Short-Term Memory (LSTM) adaptation component embedded within the Enhanced Overtime Code Mapping Tool, the LSTM adaptation component configured to analyze temporal patterns in the overtime data to adjust FTE calculations based on anomalies and emergency events;
a reinforcement learning optimization component configured to iteratively refine an FTE assignment based on historical overtime outcomes and budget constraints;
a clustering component configured to detect cost drivers in the overtime data and identify patterns influencing one or more FTE requirements across positional ranks and facility areas;
a budget compliance evaluation module configured to determine whether a calculated FTE requirement fall within a predefined budgetary threshold; and
a visualization interface configured to generate 3D surfaces representing FTE needs versus budget across rank and coverage hours.

12. The system of claim 11, wherein the overtime data comprises in-budget and out-of-budget overtime hours categorized by an overtime code and a positional rank.

13. The system of claim 11, wherein the LSTM adaptation component is configured to adjust FTE estimates in response to detected anomalies including facility-added posts and emergency events.

14. The system of claim 11, wherein the reinforcement learning optimization component is configured to minimize out-of-budget overtime while maintaining operational coverage.

15. The system of claim 11, wherein the clustering component applies unsupervised learning to identify latent cost groupings in overtime activity.

16. The system of claim 11, wherein the budget compliance evaluation module includes a within-budget determination step that triggers a feedback loop to the reinforcement learning optimization component when budget thresholds are exceeded.

17. The system of claim 11, wherein the visualization interface displays stacked bar charts and pie charts to represent overtime trends and predictive forecasts.

18. The system of claim 11, wherein the Enhanced Overtime Code Mapping Tool produces an FTE mapping F(r, h), where r represents rank and h represents hours, for use in subsequent staffing and budgetary decisions.

19. The system of claim 11, wherein an RMSprop algorithm is used to refine FTE calculations and improve cost accuracy.

20. The system of claim 11, wherein the Enhanced Overtime Code Mapping Tool is integrated with a Schedule Mapping Tool and a Governed System Compliance Engine to ensure jurisdictional compliance of staffing recommendations.
